(19) United States
(12) Patent Application Publication
(10) Pub. No.: US 2019/0100102 A1
(43) Pub. Date: Apr. 4, 2019

(54) Vehicle Information System and Method Thereof

(71) Applicants: Shanghai XPT Technology Limited, Shanghai City (CN); Intelligence & Partner Limited, Hong Kong (HK); Mindtronic AI Co.,Ltd., Grand Cayman (KY)

(72) Inventors: Mu-Jen Huang, Taipei City (TW); Ya-Li Tai, Taoyuan City (TW); Yu-Sian Jiang, Kaohsiung City (TW)

(21) Appl. No.: 15/989,152

(22) Filed: May 24, 2018

(30) Foreign Application Priority Data
Sep. 30, 2017 (CN) 201710938864.1
Sep. 30, 2017 (CN) 201721308471.4

(51) Int. Cl. B60K 35/00; H04N 5/232; B60K 37/02; B60R 1/00

(52) U.S. Cl. CPC B60K 35/00; H04N 5/23293; G06T 11/60; B60R 1/00; B60K 37/02

(57) ABSTRACT

A vehicle information system includes an image capturing module, configured to capture instant traffic images in front of a vehicle, and a dashboard, connected to the image capturing module, configured to present vehicle information concerning the vehicle and the instant traffic images. With the design of the vehicle information system, the driver will always stay alerts and be aware of the traffic condition even if his or her is looking down to the vehicle information presented on the dashboard.

### BACKGROUND OF THE INVENTION

### 1. Field of the Invention

The present invention relates to a vehicle information system, and more particularly, to a dashboard for displaying the traffic images in front of a vehicle for informing the driver about the vehicle information as well as the traffic condition.

### 2. Description of the Prior Art

A modern vehicle equips with a dashboard to provide necessary information concerning the vehicle to the driver. When driving, drivers of vehicles must read those information from time to time to avoid, for instance, speeding or any potential damage caused by a too high temperature of the water tank.

Typically, there are two types of vehicle dashboard; one is analog showing information by meter pointers while the other displays the same digitally. A pointer-based dashboard indicates a vehicle's status (such as the vehicle speed, the revolution speed, the water tank temperature and the fuel volume) by meter pointers. On the other hand, a digital-based dashboard indicates the same information digitally through a digital display (such as a liquid crystal display or an organic light-emitting diode (OLED) display).

In a scenario where a driver is too busy reading the information showing on the dashboard, either an analog or a digital one, to pay sufficient attentions to what is happening ahead, he or she may not be able to response immediately if any sudden condition occurs and consequently results in a serious tragedy.

### SUMMARY OF THE INVENTION

In view of the foregoing, the present invention discloses a vehicle information system and a method of displaying instant traffic images as well as vehicle information on a dashboard.

The present invention discloses a vehicle information system. The vehicle information system includes: an image capturing module, configured to capture instant traffic images in front of a vehicle, and a dashboard, connected to the image capturing module, configured to present vehicle information concerning the vehicle and the instant traffic images.

The present invention also discloses that a dashboard arranged in a vehicle. The dashboard includes: a plurality of layouts for displaying vehicle information concerning the vehicle and instant traffic images captured by an image capturing module; wherein the digital display presents the vehicle information and the instant traffic images in accordance with one of the layouts.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a vehicle information system according to the present disclosure.

FIG. 2 is a schematic diagram of a dashboard of a vehicle information system according to the present disclosure.

FIG. 3 is a schematic diagram of a vehicle information system according to one embodiment of the present disclosure.

FIGS. 4-6 are schematic diagrams of various layouts of a dashboard provided for displaying instant traffic images and information concerning a vehicle according to the present disclosure.

FIG. 7 is a flowchart of an exemplary process according to the present disclosure.

### DETAILED DESCRIPTION

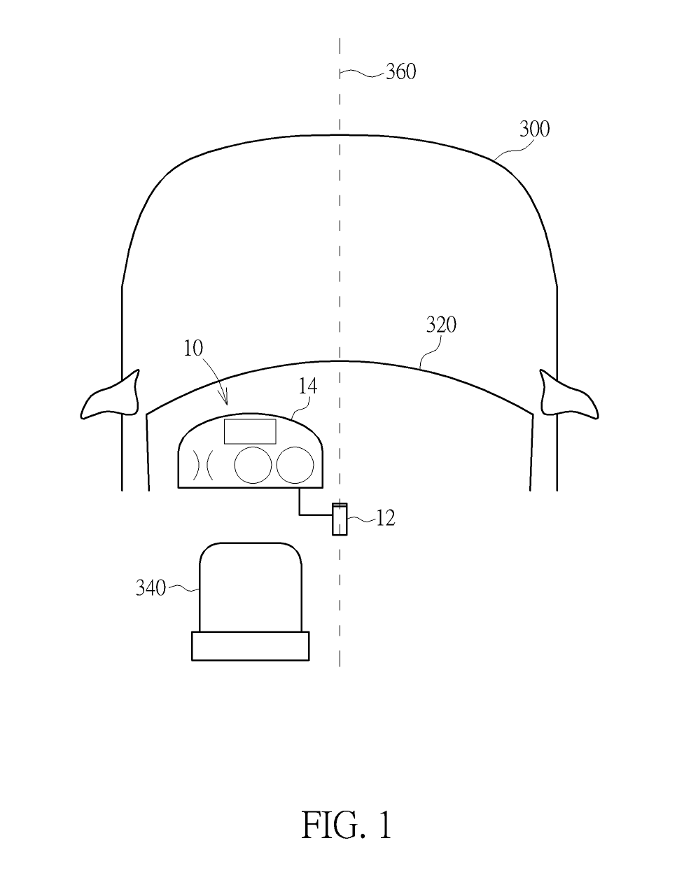

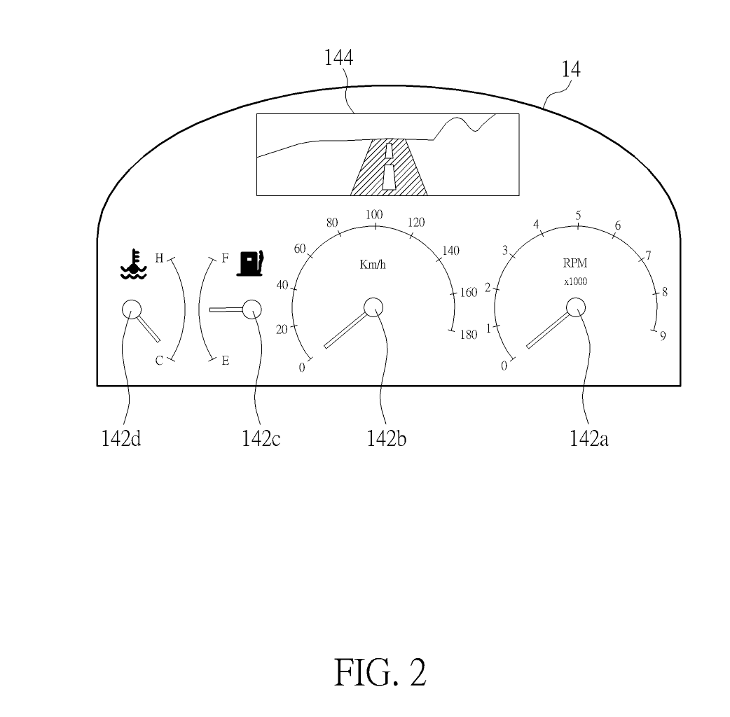

FIG. 1 illustrates a vehicle information system according to the present disclosure. FIG. 2 further illustrates a dashboard of the vehicle information system of FIG. 1.

The vehicle information system 10 is arranged in a vehicle 300. The vehicle information system 10 includes an image capturing module 12 and a dashboard 14. Additionally, the vehicle information system 10 may further include a plurality of sensors (not shown in the diagram) gathering information concerning of the vehicle 300, and a processor (also not shown in the diagram) processing data/images collected by the sensors and the image capturing module 12.

The image capturing module 12 continuously captures instant traffic images in front of the vehicle 300. The dashboard 14 is connected to the image capturing module 12 and is configured to present information of the vehicle 300 and display the instant traffic images captured by the image capturing module 12. The vehicle information may include, without limitation, the speed, the revolution per minute (RPM), the fuel volume of the fuel tank, and the water tank temperature of the vehicle 300.

The dashboard 14 is arranged in the front part of the interior of the vehicle 300. As depicted in FIG. 2, the dashboard 14 is arranged right in front of the driver, but it can alternatively be wherever convenient to the driver. Moreover, the dashboard 14 may be of various sizes as well. In addition, the image capturing module 12 may be arranged anywhere in the vehicle capable of capturing images clearly and soundly. For example, without limitation, as shown in FIG. 1, it may be arranged in a position alongside the central axis 360, such as in the middle of a windshield 320 of the vehicle 300. Alternatively, the image capturing module 12 may also be arranged in the back of a rearview mirror, or in the middle of a bumper (not shown in the diagram).

In the present invention, the dashboard 14 of the vehicle information system 10 may have different layouts to present the necessary information. FIG. 2 shows one example. As show, the dashboard 14 is analog and includes a plurality of meters for presenting the information of the vehicle 300. For example, the meters may include a tachometer 142a, a speedometer 142b, a tank gauge 142c, and a water temperature gauge 142d. Apart from that, the dashboard 14 may also include other meters for providing additional information relevant to the vehicle 300. The dashboard 14 further includes a monitor 144 for displaying the instant traffic images continuously captured by the image capturing module 12. By providing the monitor 14, the present invention allows the driver to stay alerts about the traffic condition even if he or she is looking down to read the vehicle information showing on the dashboard 14. In some embodiment, depending on the design, the meters 142a, 142b, 142c and 142d and the monitor 144 may be deployed separately in the different areas of the dashboard 14. Preferably, as shown in FIG. 2, the monitor 144 is arranged above the meters 142a, 142b, 142c and 142d.

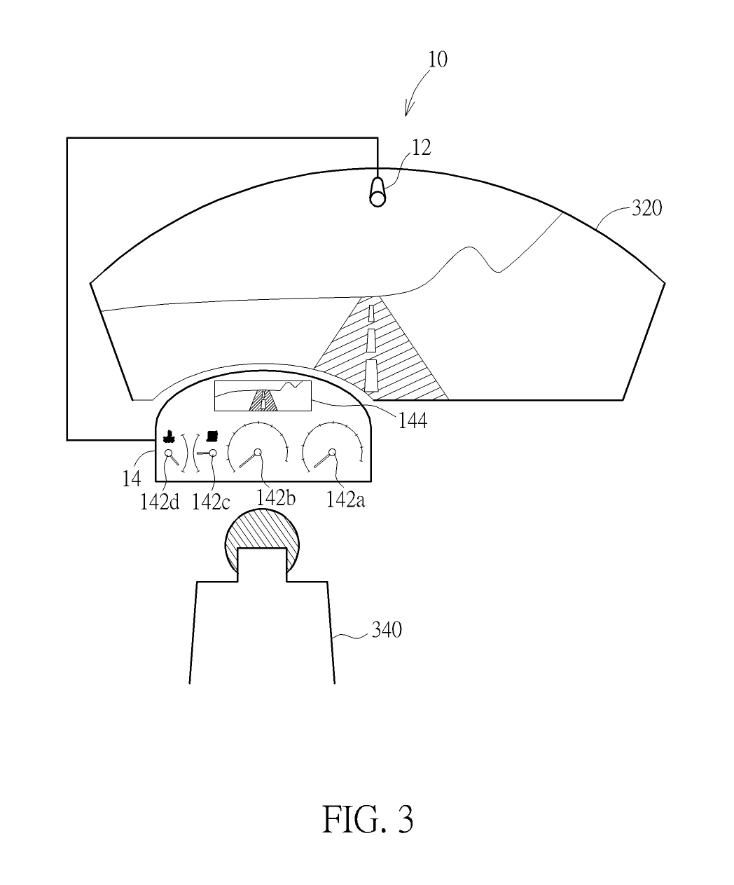

FIG. 3 illustrates a vehicle information system according to the present disclosure. The vehicle information system 10 is arranged in the vehicle 300 and includes the image capturing module 12 and the dashboard 14. The image capturing module 12 is arranged in the middle of a windshield 320 of the vehicle 300 to continuously capture instant traffic images in front of the vehicle 300. The dashboard 14 is arranged in front of a driver's seat 340 of the vehicle 300. The meters 142a, 142b, 142c and 142d are used to provide the vehicle information of the vehicle 300, and the monitor 144 is used to display the instant traffic images. Based on the design, when the driver is looking down to read the meters 142a, 142b, 142c and 142d, the driver is also aware of the traffic condition ahead through the images continuously captured by the image capturing device 12 and displayed on the monitor 144. In brief, the present invention provides a vehicle information system 10 which allows the driver to stay alerts even if his or her eyes are turned away to read the vehicle information.

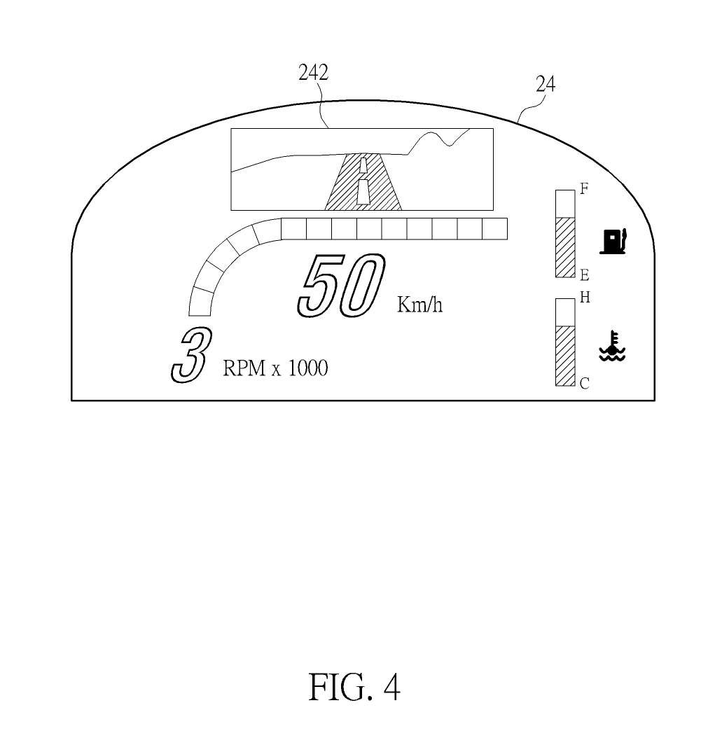

FIG. 4 illustrates another layout of the dashboard 24 according to the present disclosure. In the current embodiment, the dashboard 24 is digital. The dashboard 24 includes a digital display (such as a liquid crystal display or an organic light-emitting diode (OLED) display) for displaying vehicle information and traffic images ahead of the vehicle 300.

In addition, the digital display of the dashboard 24 may be divided into several segments. One of which includes a window 242 designated for displaying the instant traffic images continuously captured by the image capturing module 12. The rest segments are assigned for showing the vehicle information such as the instant speed and the revolution per minute (RPM), etc. As shown in FIG. 4, the instant traffic images and the vehicle information may be displayed separately in the distinctive segments on the digital display of the dashboard 24 without overlay. Preferably, the speed and the revolution per minute (RPM) are on the lower part of the digital display; on the other hand, the information related to the fuel volume and the water tank temperature are arranged at the right-hand side. It should be noted that such arrangement, including the place and the size of each segment, as depicted in FIG. 4 is arrangeable depending on the design and preferences. For instance, in the example of FIG. 4, the window 242 is placed at the upper position of the digital display, above all the segments provided for the vehicle information; but, if the driver prefers, he or she may adjust the place and even enlarge the size of the window 242 to get a better view on the traffic condition ahead of him/her.

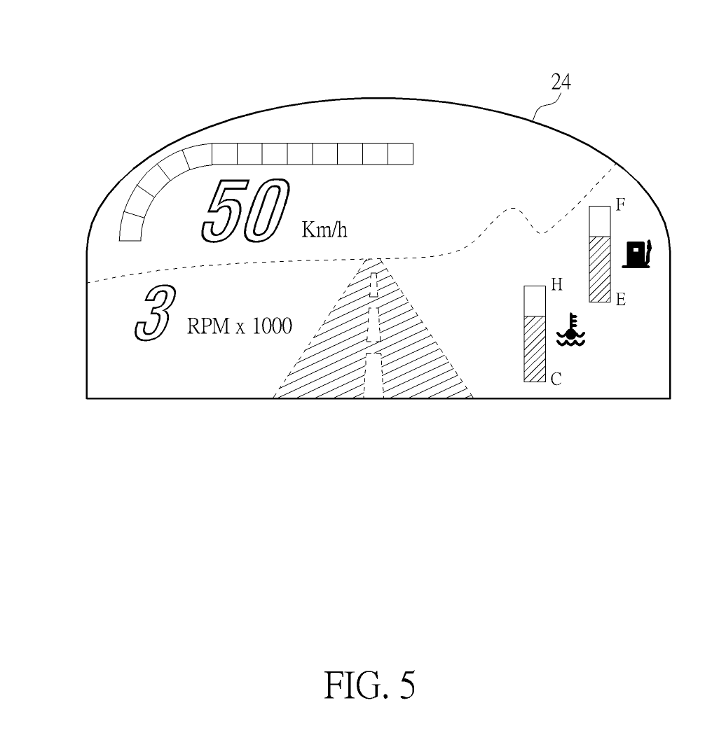

FIG. 5 illustrates further exemplary layout of the dashboard 24 according to the present disclosure. In this embodiment, the instantly captured traffic images are displayed on the entire digital display of the dashboard 24 with a certain degree of transparency. In other words, the instant traffic images are semi-transparently laying over the digitally represented vehicle information also on the digital display without affecting the driver's reading of the vehicle information. The instant traffic image is represented by dot-line in FIG. 5 to indicate it is semi-transparent; while the vehicle information such as the speed and the revolution per minute (RPM) are in solid-line to show their non-transparency. The layout provides a large resolution on the display of the instant traffic images; thus, the driver can easily be aware of the traffic condition.

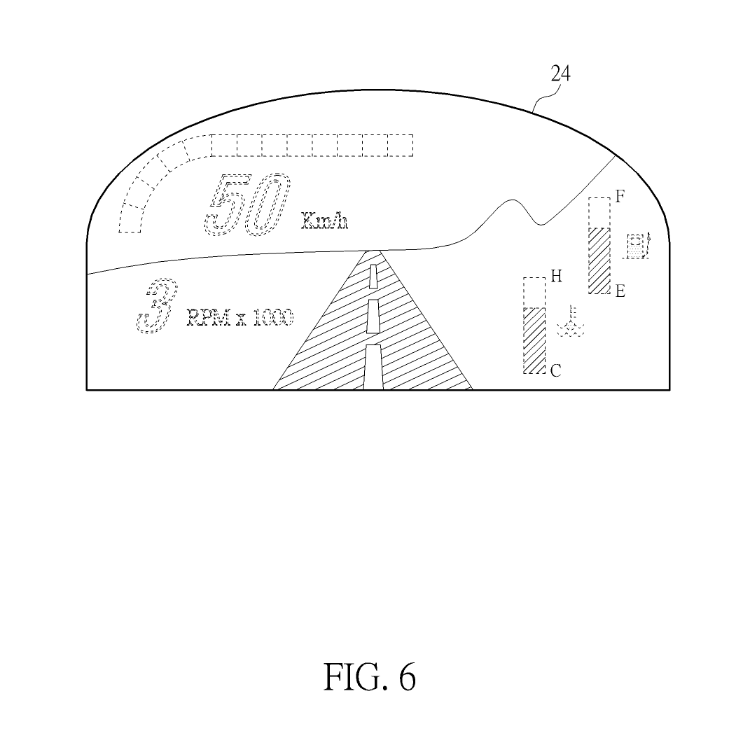

Alternatively, as shown in FIG. 6, the vehicle information (depicted in dot-line in FIG. 6) is displayed on the digital display of the dashboard 24 with some sort of transparency laying over the instant traffic images which is without transparency (depicted in solid-line in FIG. 6). The current embodiment can also provide a better resolution for the display of the instant traffic images.

FIGS. 2 and 4 to 6 demonstrate various designs of layouts to display the instant traffic images as well as the vehicle information on the dashboard in accordance with the present invention. The vehicle information system 10 in accordance with the present invention may provide only one layout as the manufacturer thinks fit. On the other hand, the manufacturer may implement all or part of the layouts into the vehicle information system 10 and therefore provide multiple display modes allowing the driver to choose from.

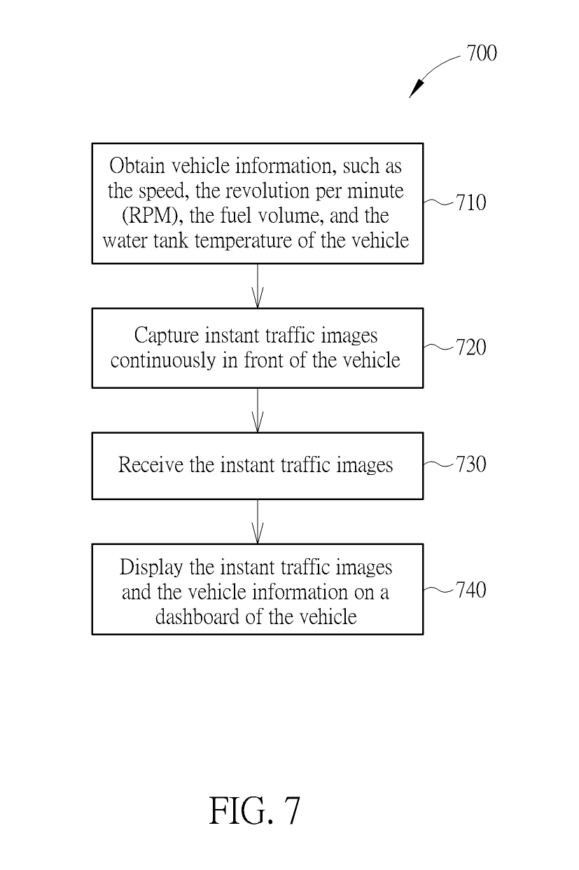

FIG. 7 shows a flowchart of an exemplary process according to the present disclosure. The process 700 includes the following steps:

Step 710: Obtain vehicle information, such as the speed, the revolution per minute (RPM), the fuel volume, and the water tank temperature of the vehicle;

Step 720: Capture instant traffic images continuously in front of the vehicle;

Step 730: Receive the instant traffic images;

Step 740: Display the instant traffic images and the vehicle information on a dashboard of the vehicle.

The present invention discloses a vehicle information system and a dashboard for displaying instant traffic images ahead of a vehicle together with the vehicle information. Based on the present invention, the driver will always stay alerts and be aware of the traffic condition even when he or she is looking down to read the vehicle information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vehicle information system, comprising:
an image capturing module, configured to capture instant traffic images in front of a vehicle; and
a dashboard, connected to the image capturing module, configured to present vehicle information concerning the vehicle and the instant traffic images.

2. The vehicle information system of claim 1, wherein the dashboard comprises:
a plurality of meters, configured to present the vehicle information concerning the vehicle; and
a monitor, configured to display the instant traffic images;
wherein the plurality of meters and the monitor are deployed separately in the different locations on the dashboard.

3. The vehicle information system of claim 2, wherein the meters may be a speedometer, a tachometer, a fuel gauge, and a tank gauge.

4. The vehicle information system of claim 1, wherein the dashboard further comprises a digital display divided into a plurality of segments, wherein the vehicle information and the instant traffic images are separately displayed in the distinctive segments on the digital display of the dashboard.

5. The vehicle information system of claim 1, wherein the dashboard further comprises a digital display, and wherein the instant traffic images are displayed on the digital display with a certain degree of transparency laying over the vehicle information also displayed on the digital display without transparency.

6. The vehicle information system of claim 1, wherein the dashboard further comprises a digital display, and wherein the vehicle information is displayed on the digital display with a certain degree of transparency laying over the instant traffic images also displayed on the digital display without transparency.

7. The vehicle information system of claim 1, further comprising a plurality of sensors arranged in the vehicle and configured to gather the vehicle information.

8. The vehicle information system of claim 1, further comprising a processing unit configured to proceed the vehicle information and the instant traffic images.

9. The vehicle information system of claim 1, wherein the vehicle information comprises: the speed of the vehicle, the revolution per minute (RPM) of the vehicle, the fuel volume of the vehicle, or the water tank temperature of the vehicle.

10. A dashboard arranged in a vehicle, comprising:
a plurality of layouts for displaying vehicle information concerning the vehicle and instant traffic images captured by an image capturing module;
wherein the digital display presents the vehicle information and the instant traffic images in accordance with one of the layouts.

11. The dashboard of claim 10, wherein the vehicle information may be gathered by various sensors disposed on the vehicle.

12. The dashboard of claim 10, wherein the vehicle information may include the speed, the revolution per minute (RPM), the fuel volume, and the water tank temperature of the vehicle.

13. The dashboard of claim 10, further comprising a digital display for displaying the vehicle information and the instant traffic images digitally.

14. The dashboard of claim 13, wherein in one of the layouts, the digital display is divided into a plurality of segments, and wherein the vehicle information and the instant traffic images are separately displayed on the distinctive segments of the digital display.

15. The dashboard of claim 14, wherein the location and the size of each segment are adjustable.

16. The dashboard of claim 13, wherein in one of the layouts, the instant traffic images are displayed on the digital display with a certain degree of transparency laying over the vehicle information also displayed on the digital display without transparency.

17. The dashboard of claim 13, wherein in one of the layouts, the vehicle information is displayed on the digital display with a certain degree of transparency laying over the instant traffic images also displayed on the digital display without transparency.

18. The dashboard of claim 10, further comprising:
a plurality of meters, configured to present the vehicle information; and
a monitor, configured to display the instant traffic images.

19. The dashboard of claim 18, wherein the meters and the monitor are deployed separately in the different locations on the dashboard.

20. The dashboard of claim 18, wherein the meters may be a speedometer, a tachometer, a fuel gauge, and a tank gauge.
